(19) United States
(12) Patent Application Publication
(10) Pub. No.: US 2007/0068403 A1
(43) Pub. Date: Mar. 29, 2007

(54) High volume inkjet garment printer with heat presses

(76) Inventors: Scott Otto Fresener, Scottsdale, AZ (US); Scott Michael Fresener, Mesa, AZ (US); Patricia Ann Fresener, Scottsdale, AZ (US)

Correspondence Address: ETHERTON LAW GROUP, LLC, 5555 E. VAN BUREN STREET, SUITE 100, PHOENIX, AZ, 85008, US

(21) Appl. No.: 11/522,135

(22) Filed: Sep. 14, 2006

Related U.S. Application Data
(63) Continuation-in-part of application No. 11/414,634, filed on Apr. 27, 2006.
(60) Provisional application No. 60/717,469, filed on Sep. 14, 2005.

(51) Int. Cl. B41F 15/04

(52) U.S. Cl. 101/115

(57) ABSTRACT

A method and apparatus for printing images on a high volume of printable substrates such as garments is disclosed. The apparatus comprises an inkjet printer, a conveyor system, heat presses and beds. The beds are trays with garment attachments such as platens for holding multiple garments in place during printing. In the preferred embodiment, the method first involves loading garments onto the beds and platens. The beds then travel along the conveyor system which includes one or more conveyor tables and optional heat presses. The beds are preferable placed under a heat press for pre-pressing the garments. Then the conveyor system facilitates the transfer of the beds to a high volume inkjet printer, where both an underbase and an image can be printed on each garment. After printing images on the garments, the beds are transferred again to the conveyor system and optionally delivered to another heat press to cure the image. Finally, the garments are unloaded from the beds and new un-printed garments are loaded.

### CROSS-REFERENCE TO RELATED APPLICATIONS

This application claims the benefit of co-pending provisional application 60/717,469 filed Sep. 14, 2005 and co-pending application Ser. No. 11/414,634 which claims the benefit of co-pending patent application Ser. No. 11/101,084 filed Apr. 7, 2005, claiming priority to co-pending provisional application Ser. No. 60/647,560 filed Jan. 27, 2005, co-pending provisional application Ser. No. 60/675,641 filed Apr. 27, 2005, and co-pending provisional application Ser. No. 60/774,585 filed Feb. 16, 2006.

### FIELD OF INVENTION

The present invention relates to inkjet printing images on printable substrates. More particularly, this invention relates to an apparatus for mass-producing garments with inkjet printed images.

### BACKGROUND

There are two preferred methods for printing images on textiles: screen printing and inkjet printing. Screen printing is the older method and is currently used primarily for printing on garments such as t-shirts, shorts, underwear, and other clothing. To screen print an image, a stencil of the desired image is created on mesh fabric which is stretched across a frame. The mesh stencil is placed over the textile and ink is applied by squeegee to the stencil and is forced through holes in the mesh onto the textile. The ink is cured after it has been applied to the textile.

To print high volumes of garments, screen printing uses a rotary press (often referred to as a “speed table”) that consists of a central base with several arms, each of which is connected to a platen that holds the textile being printed. The platens are rotated around the base to various stations at which the different steps in the screen printing process occur. While screen printing is an effective method of printing images on textiles, it is time consuming because only one color can be applied per station. This means that, for example, in order to print a shirt with three colors, three stencils must be created, the shirt must rotate through at least three separate stations to apply color, each of which may be separated by a cure station. While more time-consuming than desirable, screen printing easily prints the rainbow of colors, as well as white and black.

Inkjet printing is newer and is used to print yard goods in bulk and, more recently, individual garments. Inkjet printers are significantly faster than traditional screen printers and can print more highly-detailed designs. Inkjet printers function by moving an inkjet cartridge with a print head back and forth over a substrate. The print head dispenses ink through a series of nozzles using known technologies such as thermal bubble jet, piezoelectric, or valve jet dispensing mechanisms. Each nozzle is fed by a well of ink. Inkjet printers print the rainbow of colors, as well as black and white.

Inkjet printers are broadly categorized in two varieties: small and large format. Small inkjet printers (“small format printers”) print on single pieces of paper and other discrete items such as garments. Small format printers use print heads with smaller nozzles, typically bubble jet or piezoelectric, that dispense less ink than large format printers. Large format printers print on continuous-feed surfaces such as raw fabric, carpets, signs, and banners. These large format printers use large nozzles, typically valve jets, for dispensing a large quantity of ink onto a substrate.

Small format printers are smaller and less expensive than large format printers. Small format printers are desirable because they can be incorporated with a rotary press and vastly reduce the amount of time required to print an image on a garment and increase throughput. For example, instead of screen printing a three-color image onto a textile using three different stencils, one inkjet printer can print the entire three-color image directly onto the textile at a single station. This frees-up other stations to print other t-shirts at the same time. Another advantage of using an inkjet printer is that one can design an image on the computer using software such as Corel® Photoshop® software and send it directly to the inkjet printer; no laborious process of making screens is required. A disadvantage of small format printers is that they can print only a single garment at a time.

Large format printers are used to print materials that can be fed by rolls, such as yard goods and banners. Large format printers are typically flat-bed and roll-fed. Fabric is pulled from a roll and fed under two carriage rails closely spaced to the fabric. The fabric rests on a belt that helps carry the fabric through the printer. The newly-printed fabric is dried and rolled up again on take-up rolls. Through-put capacities can be 30-50 square meters/hour at resolutions from 360 to 720 dpi for up to 8 colors at a printable width of 1.8 m. The large format printers can handle most fabric types, including stretch, knits and wovens. The roll-to-roll feeding system maintains uniform fabric transport to ensure the highest print quality, even on stretch fabrics. A built-in washing mechanism keeps the belt free of ink, ensuring that no ink is transferred to the back of the fabric. The printer includes 16 print heads on 2 carriage rails for maximum speed and flexibility. The print head carriage height can be adjusted up to 10 millimeters above the fabric to accommodate many thick substrates, as well as the thinnest, most delicate fabrics. Such printers are available commercially, from DuPont, Mutoh, and Mimaki.

Mass-production digital printers are known only for yard goods, however, and are not known to print garments. Several reasons prevent known digital printers from mass-producing garments. For example, the digital printers known in the art require that the substrate be fed from one roll and to another roller; t-shirts and hats simply can't be fed by rolls. The print heads on digital printers pass very closely to the flat span of fabric passing beneath them; garments wouldn't fit between the print heads and the belt. It would be desirable to be able to mass-produce garments using an inkjet printer.

Historically, printing white images on dark garments also has been particularly difficult because the ink needs to be opaque enough to “hide” the color of the shirt. Images that are multi-color are typically first screen printed with a light colored base or “underbase” that is used to block the shirt color. Additional colors are then screen printed on top of the base. Recently, a process has been developed that enables an image to be printed by inkjet on a screen-printed underbase. See related U.S. patent application Ser. No. 11/101,084 filed Apr. 7, 2005. Also recently, a process has been developed that enables a light-colored or white underbase, or even a white image, to be directly inkjet printed on garments. See related U.S. patent application Ser. No. 11/414,634 filed Apr. 27, 2006. It would be desirable to mass produce dark garments with white images.

Another challenge when mass-producing printed garments has been moving the garments to a heat press efficiently. Heat presses are primarily used for pre-pressing a garment before printing or for curing the image on the garment after printing. Traditionally, garments are removed from the printing device and placed through a stand-alone oven or heat transfer heat press. It would be desirable to include a heat press as part of a printing system for mass-producing inkjet printed garments.

Therefore, one object of this invention is to provide an apparatus that can digitally print large quantities of garments. Another object of this invention is to provide an apparatus that can inkjet print large quantities of garments. Another object of this invention is to provide an apparatus that can inkjet print large quantities of garments that have white images on a dark substrate. A further object of this invention is to provide an apparatus that can inkjet print large quantities of dark t-shirts with white images. Finally, another object of this invention is to provide a method and apparatus that incorporates heat presses.

### SUMMARY OF THE INVENTION

The present invention is a high-volume garment printer and a method for printing a high volume of garments. The apparatus comprises a series of conveyor tables and one or more garment beds used in cooperation with a large-format inkjet printer. The beds are trays with attachments for holding garments in positions such that the desired print surface of the garment is substantially flat and parallel to the printer's carriage rail. The preferred embodiment uses platens that are attached to the tray. Cap attachments, sleeve attachments, and attachments for other garments can be used in conjunction with the beds, as well. The conveyor tables support the beds and enable them to be easily transported to and from the printer. Preferably the tables are not affixed to the printer. The conveyor tables can additionally support heat presses at various locations.

To print large quantities of garments, the garments are loaded on the attachments. If desired, the beds are moved along the conveyor tables and, one bed at a time, positioned under one of the heat presses to prepare the garments for printing. Then, each bed is moved from the conveyor tables to a position allowing the inkjet printer's belt to carry the bed through the printer under the print heads. In the preferred embodiment, the inkjet printer has two carriage rails, each of which is raised above the belt to accommodate the height of the beds. In the preferred embodiment the first rail encountered by the garments prints a white underbase. The second rail prints a desired image, which may include white, black, as well as any of the rainbow of colors. After being carried through the printer, each bed moves back onto the conveyor tables to be moved through a dryer or heat press, if desired. Then the garments are unloaded from each bed.

### BRIEF DESCRIPTION OF THE DRAWINGS

FIG. 1 is a top view of the conveyor system of the preferred embodiment of the present invention.

FIG. 2 is a top view of the bed with five platens.

FIG. 3 is a side view of the bed with five platens.

FIG. 4 is a side view of the bed with five platens, each draped in a t-shirt.

FIG. 5 is a top view of the preferred embodiment of the present invention with beds of t-shirts being processed through an inkjet printer.

FIGS. 6a-6f are top views of combinations of light and dark t-shirts and various desired images.

FIG. 7a is a top view of the optional heat press of the present invention.

FIG. 7b is a top view illustrating the high-volume inkjet garment printer with optional heat presses.

FIG. 8 is a side view illustrating heating elements poised over a tray of t-shirts.

### DETAILED DESCRIPTION OF THE INVENTION

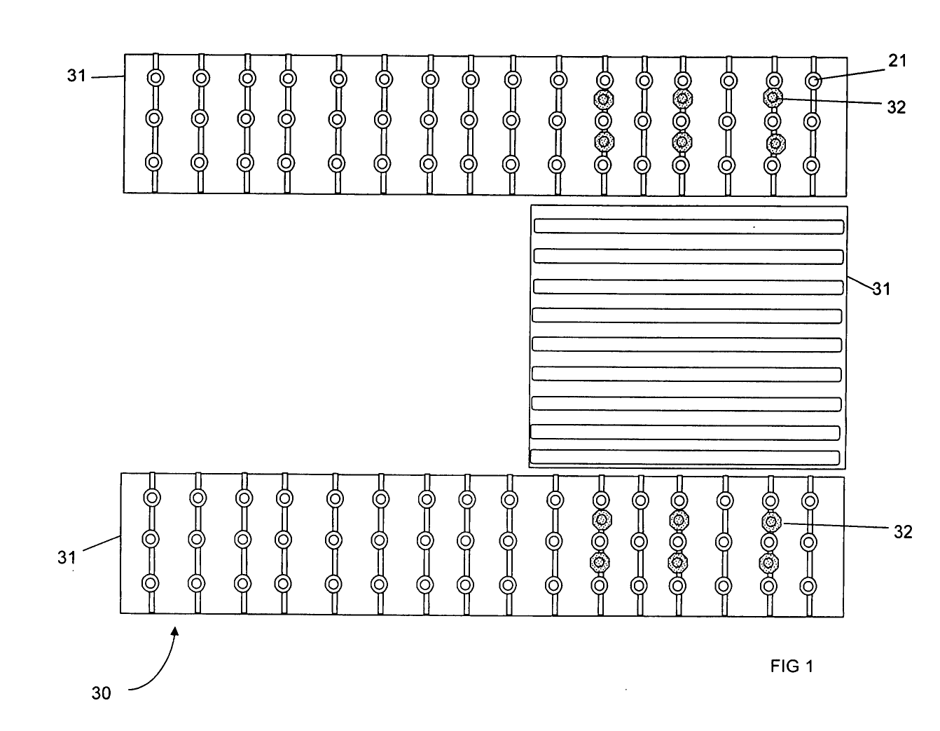

FIGS. 1-5 generally show that the apparatus comprises at least one bed 22 for carrying one or more garments or printable substrates and a conveyor system 30, both of which work in cooperation with an inkjet printer 11. The apparatus can be used to print any type of garment, such as shirts, hats, underwear, etc. by loading each garment onto an appropriate attachment device. The apparatus can also be used to print on any color of garment, from white to darker colors such as black.

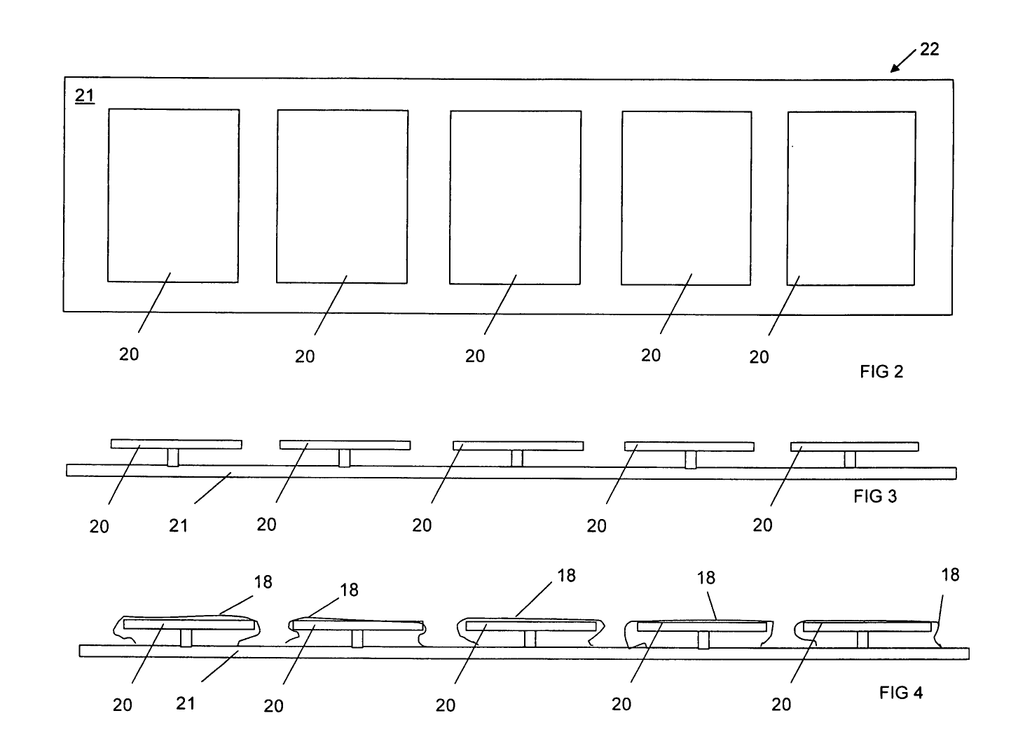

FIGS. 2, 3 and 4 show bed 22 in detail. Bed 22 is designed to carry a batch of any type of garment or printable substrate. Bed 22 comprises a tray 21 with garment attachments 20 affixed thereto for holding each garment in position such that the desired print surface of the garment is substantially flat and parallel to a printer's carriage rail. For example, the garment attachment for printing t-shirts is a shirtboard or platen. FIG. 4 shows garment attachment 20 as a platen loaded with a t-shirt 18. In the preferred embodiment of bed 22, tray 21 has five platens 20 for holding five t-shirts 18. Tray 21 can have more or fewer garment attachments, however, depending on what is desired by the user. Additionally, shirtboards or platens can come in a variety of sizes to accommodate different size garments, such as child-sized shirts, adult shirts or oversized shirts. Moreover, other shaped garment attachments can be used, such as hat attachments, sleeve attachments, or any other type of garment attachment depending on which type of garment or printable substrate an image will be printed, as is known in the art. The garment attachments can rest on the tray, be permanently affixed to the tray, or be removable and interchangeable.

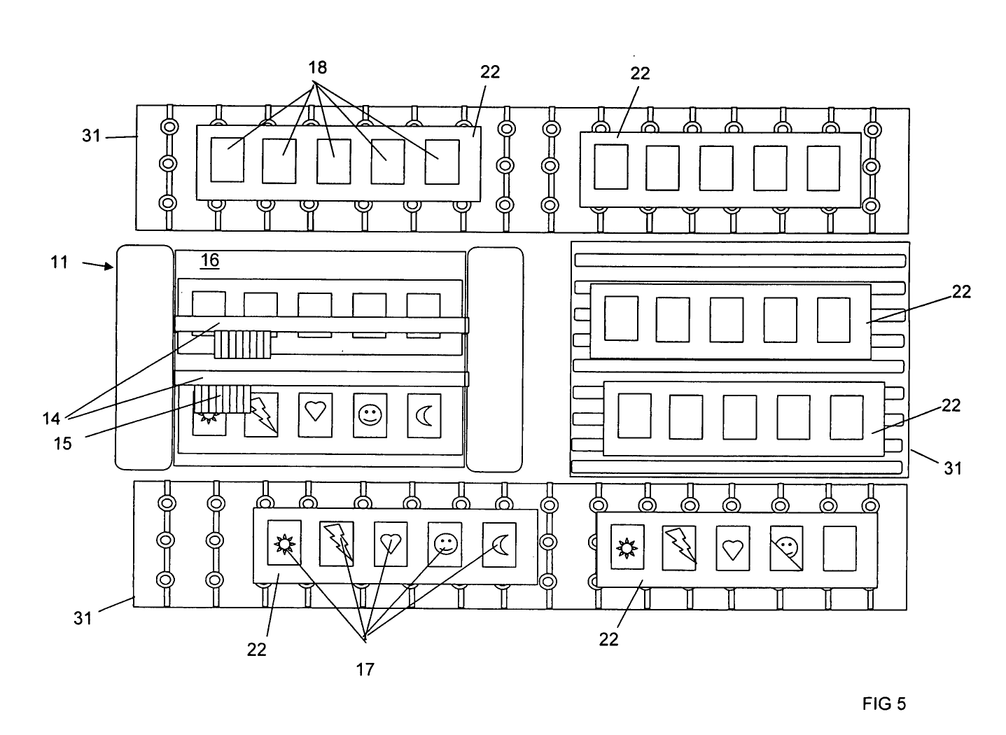

FIG. 5 illustrates inkjet printer 11 as it cooperates with conveyor system 30. Inkjet printer 11 comprises a belt 16 with an entrance and an exit for carrying bed 22 through inkjet printer 11 and at least one carriage rail 14. In the preferred embodiment, inkjet printer 11 has two carriage rails 14. The carriage rails are elevated above belt 16 a sufficient amount to accommodate the height of bed 22 loaded with garments. Each rail 14 conveys a battery of print heads 15 and inkwells. Print heads 15 translate along the rails 14 back and forth across the width of the belt 16 and dispense ink at the appropriate places to create a desired image 17 on each t-shirt 18 or other printable substrate. The movement of print heads 15 along carriage rails 14 and the dispensing of ink are computer controlled. Belt 16 is also computer controlled to cooperate with the print heads 15 and to carry bed 22 through inkjet printer 11 as needed for printing desired image 17. While in the preferred embodiment inkjet printer 11 uses a belt, any type of computer-controllable garment carrying method can be used to move bed 22 through inkjet printer 11, such a chain-link or roller bar conveyor.

In the preferred embodiment, inkjet printer 11 is a modified large format printer, such as the DuPont Aritistri 2020 roll-to-roll textile printer. Printer 11 has sixteen print heads with drop-on-demand piezoelectric nozzles, although any type of print head and print nozzle can be used, as is known in the art. Further in the preferred embodiment, eight of the print heads dispense white ink along a first rail for creating an underbase on a garment, and the other eight print heads dispense colored ink along a second rail for printing the desired image 17 over the underbase. The eight colors are cyan, magenta, yellow, black, orange, red, green and blue. Additional rails can be used with additional print heads and additional colors. Moreover, each rail can have any number of print heads or any combination of print heads, such as combinations of print heads that dispense white ink with print heads that dispense colored or black ink, depending on what types of images are desired. Finally, the ink can also take on effects such as iridescence, puff, glitter or other decorative accents.

Both FIGS. 1 and 5 illustrate conveyor system 30. Conveyor system 30 comprises one or more conveyor tables 31. In the preferred embodiment, conveyor system 30 comprises three conveyor tables 31. Conveyor tables 31 are positioned to easily load bed 22 onto belt 16 of inkjet printer 11. Preferably, the top of conveyor tables 31 is perfectly aligned with the height of belt 16, so that bed 22 can be transferred from tables 31 to belt 16 without substantial vertical movement. Conveyor tables 31 are also preferable positioned adjacent to the entrance and exit of belt 16 but not affixed to inkjet printer 11. As shown in FIG. 5, one conveyor table 31 is adjacent to the entrance of belt 16, one conveyor table 31 is adjacent to the exit of belt 16 and one conveyor table 31 connects the previous two conveyor tables and is positioned next to inkjet printer 11. The footprint of the preferred apparatus using three conveyor tables 31 is approximately 20 feet by 12 feet.

Conveyor tables 31 preferably use rollers or roller bars 33 to transport each bed 22 easily, which is also illustrated in FIGS. 1 and 5. Other types of conveyors, such as belts or such as air conveyor tables, are acceptable as well. Moreover, some of conveyor tables 31 can use roller bars while others use belts or air. Any combination of conveyor methods can be used, as is known in the art. Additionally, the conveyor tables may also have pneumatic stops 32 that, when air pressure is applied, lift the bed off the conveyor table. This has the effect of holding the bed still while garments are loaded or unloaded.

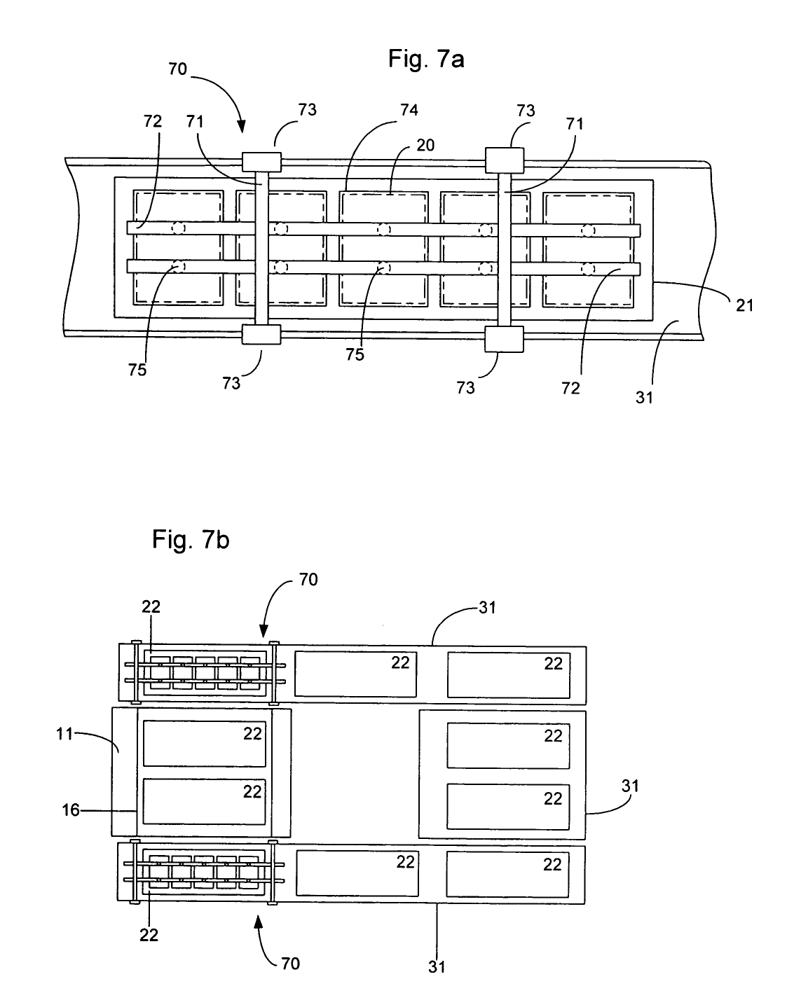

FIGS. 7a and 7b show an additional embodiment of the apparatus with optional heat press 70. Heat presses 70 are useful for pre-pressing substrates prior to loading them on inkjet printer 11 so that the garment lies flat and is dry, which improves the garment's ability to accept ink. Heat presses are also useful for curing pre-treatment before the image is printed, or for curing the image after printing. Accordingly, heat press 70 can be placed along conveyor table 31 before bed 22 is transferred from conveyor table 31 to inkjet printer 11 and along another conveyor table 31 after bed 22 is transferred from inkjet printer 11. Alternatively, one heat press can be located along conveyor system 30 to both pre-press the garments prior to printing and to cure the images on the garments after printing.

Heat press 70 may comprise one large heating element or several smaller heating elements 74 as illustrated in FIG. 7a. In the preferred embodiment, each heating element 74 corresponds to an individual platen 20 on bed 22 for best results. The heating elements are resistive materials or infrared radiators, as known in the art. Heating elements 74 are suspended from a support structure that is attached to the conveyor system 30, or more particularly, to one of conveyor tables 31.

One example of a preferable support structure when several heating elements are desired is illustrated in FIG. 7a. The support structure can be one or more vertical supports 73 that hold one or more cross supports 71 above conveyor table 31. The cross supports 71 have one or more longitudinal supports 72 that allow the heating elements 74 to all be controlled simultaneously. Each heating element 74 attaches to the longitudinal supports 72 with connectors 75. The connectors can be any method of affixing a suspended object to a support, such as self-leveling, floating bolt balanced springs, as is known in the art. If several heating elements 74 are used, then each heating element will have a corresponding connector 75 to attach it to each longitudinal support 72. Alternatively, one larger heating element can be used that may connect directly to cross supports 71. As is known in the art, various support structures can be designed so that heating elements 74 can be suspended over conveyor table 31. Additionally, the support structure can be designed so that the height of heating elements 74 is adjustable, as is also known in the art.

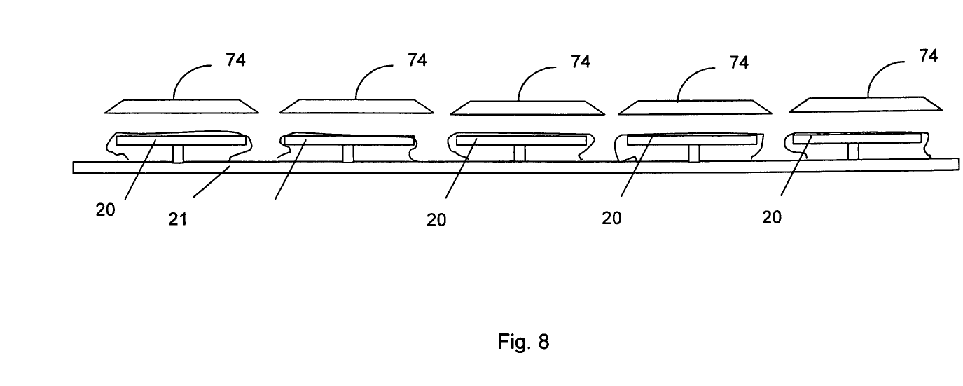

Heating elements 74 are preferably suspended over conveyor tables 31 so that when bed 22 is placed on conveyor table 31 below heating elements 74, the platens 20 with loaded t-shirts 18 do not initially make direct contact with heating elements 74. See FIG. 8. After bed 22 is placed under heating elements 74, the bed can be raised so that t-shirts 18 make contact with heating elements 74. The bed can be raised by adjusting the conveyor table for example by pneumatic stops 32 that lift bed 22 when air pressure is applied, while conveyor table 31 remains stationary. In the preferred embodiment, heating elements 74 are lowered to achieve contact between t-shirts 18 and heating elements 74, or a combination of raising beds 22 and lowering heating elements 74 can be used. Finally, if contact between t-shirts 18 and heating elements 74 is not desirable, adjustments can be made so that t-shirts 18 and heating elements 74 are positioned accordingly, as is known in the art.

To use the high-volume printer with heat presses described above, each bed 22 is first loaded with a batch of garments. For example, five t-shirts are placed on five shirtboards or platens 20. Several beds can be loaded and lined up on conveyor system 30. FIG. 5 shows the high-volume garment printing system in use with eight beds, each loaded with five t-shirts.

Once loaded, bed 22 is conveyed by conveyor table 31 to heat press 70. Bed 22 is then raised with pneumatic stops 32 to make contact with heating elements 74 and heating elements 74 press and dry t-shirts 18 so that they are optimally ready for inkjet printer 11. Alternatively, if pressing is not necessary or desired, the step of pressing and drying the t-shirts can be eliminated.

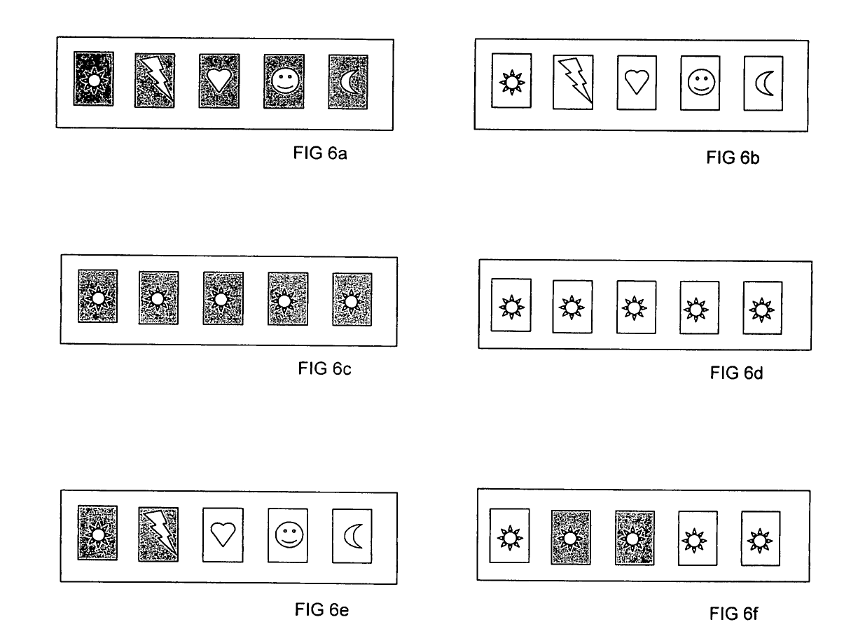

Next, bed 22 is transferred to inkjet printer 11 and positioned on belt 16. Belt 16 carries bed 22 under carriage rails 14. In the preferred embodiment, bed 22 is first carried under one of rails 14 for printing a white underbase and then under another of rails 14 for printing an image on top of the underbase. Generally, the movement of belt 16 cooperates with the movement of print heads 15 to create underbases and images on each t-shirt 18. Each image on each t-shirt on each bed can be different, as shown in FIGS. 6a, 6b, 6e, and 6f, or all the images can be the same, as in FIGS. 6c and 6d. The garments can be different colors. For example, FIGS. 6a and 6c show beds of dark t-shirts, FIGS. 6b and 6d show beds of white t-shirts, and FIGS. 6e and 6f show beds of mixed-color t-shirts.

After the desired image 17 has been applied to each t-shirt 18, the belt conveys bed 22 towards conveyor table 31 at the exit of the inkjet printer 11. Then, once bed 22 exits inkjet printer 11, it can be conveyed to another heat press 70. In the preferred embodiment, bed 22 is then again raised with pneumatic stops 32 to make contact with heating elements 74 and heating elements 74 cure images 17. Alternatively, if curing is not desired, the step of curing the images 17 can be eliminated.

Finally, t-shirts 18 having images 17 are removed, and new unprinted t-shirts are loaded onto platens 20. The process of loading, pressing, printing, curing and unloading is repeated until the desired quantity of t-shirts is printed.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

We claim:

1. An apparatus for printing on at least one substrate comprising:
a) an inkjet printer;
b) one or more beds for carrying printable substrates; and
c) a conveyor system that cooperates with bed and the inkjet printer to carry the bed under the inkjet printer.

2. The apparatus of claim 1 where in the conveyor system comprises one or more conveyor tables for transporting the beds to or from the inkjet printer.

3. The apparatus of claim 2 wherein the inkjet printer comprises:
a) a belt;
b) one or more carriage rails positioned above the belt such that the beds carrying printable substrates can pass under the rails for inkjet printing; and
c) one or more print heads disposed along the carriage rails such that the print heads can translate along the rails in response to printing commands.

4. The apparatus of claim 3 wherein the inkjet printer comprises:
a) a first rail and a first set of one or more print heads, wherein the first set of print heads delivers white ink; and
b) a second rail and a second set of one or more print heads.

5. The apparatus of claim 1 wherein a bed further comprises:
a) a tray; and
b) one or more garment attachments.

6. The apparatus of claim 5 wherein at least one of the garment attachments is a platen for holding a garment.

7. The apparatus of claim 5 wherein at least one of the garment attachments holds a hat.

8. The apparatus of claim 5 wherein at least one of the garment attachments holds the sleeve of a garment.

9. The apparatus of claim 2 wherein the conveyor table comprises rollers.

10. The apparatus of claim 2 wherein the conveyor table comprises pneumatic stops.

11. The apparatus of claim 2 further comprising at least one heat press along the conveyer system wherein the heat press comprises at least one heating element suspended over the conveyor table.

12. A method of printing images a plurality of substrates comprising:
a) loading substrates on a bed comprising one or more garment attachments;
b) transporting the bed along one or more conveyor tables to an inkjet printer;
c) transferring the bed from the conveyor tables to the inkjet printer;
d) printing one or more desired images on the substrates; and
e) transferring the bed from the inkjet printer to the conveyor tables.

13. The method of claim 12 further comprising:
a) transporting the bed on the conveyor tables to a heat press.

14. The method of claim 12 further comprising:
a) before transferring the bed from the conveyor tables to the inkjet printer, carrying the bed on the conveyor tables to a heat press; and
b) pressing the substrates.

15. The method of claim 12 wherein the conveyor tables further comprise rollers.

16. The method of claim 12 wherein the garment attachments are platens.

17. The method of claim 12 wherein the images are white.

18. The method of claim 12 further comprising printing a white underbase on the substrates before printing the desired images.

19. The method of claim 18 wherein the substrates are dark colored.

20. The method of claim 12 wherein the inkjet system further comprises:
a) one or more rails positioned above the inkjet printer carriage system such that the beds carrying printable substrates can pass under the rails for inkjet printing; and
b) one or more print heads disposed along the one or more rails such that the print heads can translate along the rails in response to printing commands.

21. An apparatus for printing on a substrate comprising:
a) an inkjet printer comprising:
1. a belt;
2. at least one rail disposed above the belt; and
3. at least one print head disposed along each rail such that the print head can translate along the rail in response to printing commands;
b) at least one conveyor table disposed adjacent to the inkjet printer;
c) at least one tray, wherein the tray can be transported by the conveyor table;
d) at least one platen affixed to each tray; and
e) at least one heat press along the conveyer system wherein the heat press comprises at least one heating element suspended over the conveyor table.
